(19) United States
(12) Patent Application Publication
(10) Pub. No.: US 2014/0043267 A1
(43) Pub. Date: Feb. 13, 2014

(54) Operation Method of Dual Operating Systems, Touch Sensitive Electronic Device Having Dual Operating Systems, and Computer Readable Storage Medium Having Dual Operating Systems

(71) Applicant: Pegatron Corporation, Taipei (TW)

(72) Inventor: Wei-Te Hsu, New Taipei City (TW)

(73) Assignee: Pegatron Corporation, Taipei (TW)

(21) Appl. No.: 13/963,113

(22) Filed: Aug. 9, 2013

(30) Foreign Application Priority Data
Aug. 10, 2012 (TW) 101129005

(51) Int. Cl. G06F 3/041

(52) U.S. Cl. CPC G06F 3/041
USPC 345/173

(57) ABSTRACT

An operation method of dual operating systems, a touch sensitive electronic device having dual operating systems, and a computer readable storage medium having dual operating systems are disclosed. The touch sensitive electronic device includes an image outputting interface and a touch sensitive screen, and is capable of operating a first operating system and a second operating system simultaneously. First, whether the image outputting interface is connected with a display device is detected when the touch sensitive screen displays the operation screen of the first operating system. Then, the operation screen of the second operating system is output to the display device via the image outputting interface when the image outputting interface is connected with the display device. Lastly, a virtual input interface is displayed on the operation screen of the first operating system displayed on the touch sensitive screen.

### CROSS-REFERENCES TO RELATED APPLICATIONS

This non-provisional application claims priority under 35 U.S.C. §119(a) on Patent Application No. 101129005 filed in Taiwan, R.O.C. on 2012 Aug. 10, the entire contents of which are hereby incorporated by reference.

### BACKGROUND

1. Technology Field

The invention relates to method for operating a system and, in particular, to a method for operating dual operating systems, a touch sensitive electronic device having dual operating systems, and a computer readable storage medium having dual operating systems.

2. Related Art

With the advances of the integrated circuit manufacturing process, the processing speed of the processors inside mobile devices becomes faster with lower power consumptions. Therefore, mobile devices such as smartphones and tablet computers have become more and more popular and can be used as means to access information (such as to access emails and browse webpages).

Furthermore, the development of touch control technology also enlarges the information display area (that is, the size of the display of a mobile device). However, in order to take into account the convenience of carrying, the display size of a mobile device is still limited to a certain degree, which limits the information display area.

Moreover, as shown in FIG. 1, which is a schematic diagram of the mobile device 100 having a touch sensitive screen 110, when an input instruction is needed, the virtual keyboard 112 displayed on the touch sensitive screen 10 occupies nearly half of the display area, resulting in the reduction of the information display area 114. In view of this, many manufacturers launched wired or wireless external keyboards so that the screen of the mobile device 100 can display information completely. However, the characteristic of the mobile device 100 is its convenience of carrying, and the external keyboards reduce such convenience and increase the burden of carrying.

As described above, along with the advances of the processor manufacturing process, processors with dual cores or multiple cores have been used in the mobile device 100. To fully utilize its performance, two operating systems have been run on such processor. For example, except for the native operating system of the mobile device 100, the processor also runs an operating system typically executed on a desktop computer (such as Ubuntu®). The former can be used by a user to perform operations which are easier and require quick results (such as browsing webpages); the latter can be used by the user to perform complex operations (such as editing documents). However, the user needs a complete user interface with a sufficient area to facilitate the document editing operations. As described previously, the mobile device 100 having the touch sensitive screen 110 suffers from the problem that it cannot provide a user interface with a sufficient input area and a sufficient information display area 114 simultaneously.

### SUMMARY

In view of the above problem, the invention provides an operation method of dual operating systems and a touch sensitive electronic device and a computer readable storage medium having dual operating systems to solve the problem existed in the prior art that the touch sensitive screen cannot provide a sufficient input area and an information display area simultaneously.

One embodiment of the invention provides an operation method of dual operating systems adapted for a touch sensitive electron device capable of operating a first operating system and a second operating system simultaneously. The touch sensitive electronic device includes a touch sensitive screen and an image outputting interface.

The operation method of the dual operating systems including: detecting whether the image outputting interface is connected with a display device when the touch sensitive screen displays the operation screen of the first operating system; outputting the operation screen of the second operating system to the display device via the image outputting interface when the image outputting interface is connected with the display device; and displaying a virtual input interface on the operation screen of the first operating system displayed on the touch sensitive screen.

Another embodiment of the invention provides a touch sensitive electronic device including a touch sensitive screen, a storage module, a processing module and an image outputting interface. The processing module is coupled with the touch sensitive screen and the storage module. The image outputting interface is coupled with the processing module for connecting to a display device.

In the embodiment, the storage module stores a first operating system and a second operating system. The processing module is capable of operating the first operating system and the second operating system simultaneously. When the image outputting interface is connected with the display device, the operation screen of the second operating system is output to the display device via the image outputting interface.

In the embodiment, the touch sensitive screen is for displaying the operation screen of the first operating system. When the image outputting interface is connected with the display, the operation screen of the first operating system on the touch sensitive screen displays a virtual input interface.

Still another embodiment of the invention further provides a computer readable storage medium having dual operating systems, which stores a computer operable program adapted for a touch sensitive electronic device capable of operating a first operating system and a second operating system simultaneously. The touch sensitive electronic device includes a touch sensitive screen and an image outputting interface, the program operating the following steps: detecting whether the image outputting interface is connected with a display device when the touch sensitive screen displays the operation screen of the first operating system; outputting the operation screen of the second operating system to the display device via the image outputting interface when the image outputting interface is connected with the display device; and displaying a virtual input interface on the operation screen of the first operating system displayed on the touch sensitive screen.

According to the operation method of dual operating systems, the touch sensitive electronic device having dual operating systems, and the computer readable storage medium having dual operating systems according to the invention, a complete user interface can be displayed on the touch sensitive screen by the first operating system, while the operation screen of the second operating system can be output via the image output interface. With such arrangement, the issue existed in the prior art that the touch sensitive screen cannot provide a sufficient input area and a sufficient information display area can be solved.

### BRIEF DESCRIPTION OF THE DRAWINGS

FIG. 1 is a schematic diagram of the input of the mobile device having a touch sensitive screen.

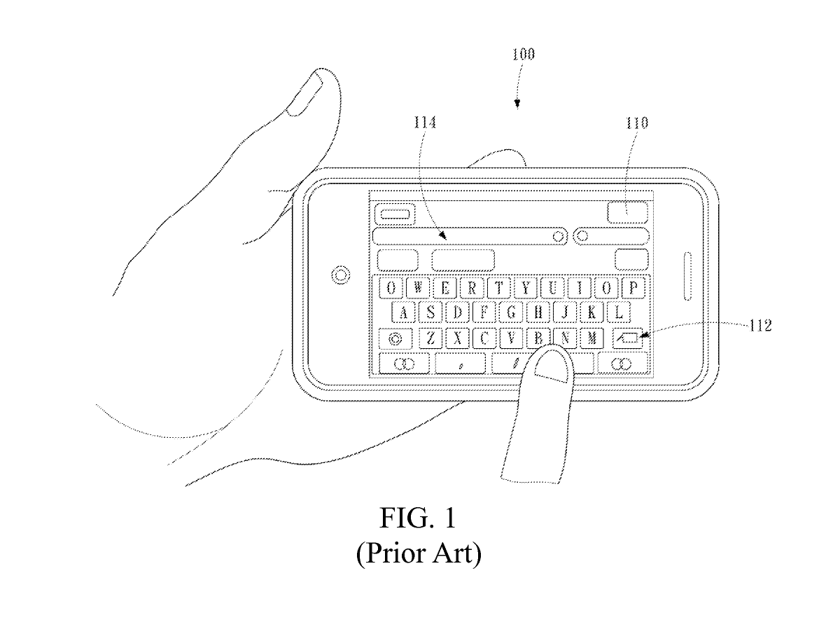

FIG. 2 is a schematic block diagram of the hardware of the touch sensitive electronic device having dual operating systems according to an embodiment of the invention.

FIG. 3 is a schematic diagram of a virtual input interface shown by the touch sensitive screen according to an embodiment of the invention.

FIG. 4 is a schematic block diagram of the software of the touch sensitive electronic device having dual operating systems according to an embodiment of the invention.

FIG. 5 is a flowchart showing the operation method (1) of the dual operating systems according to one embodiment of the invention.

FIG. 6 is a flowchart showing the operation method (2) of the dual operation systems according to one embodiment of the invention.

### DETAILED DESCRIPTION OF THE INVENTION

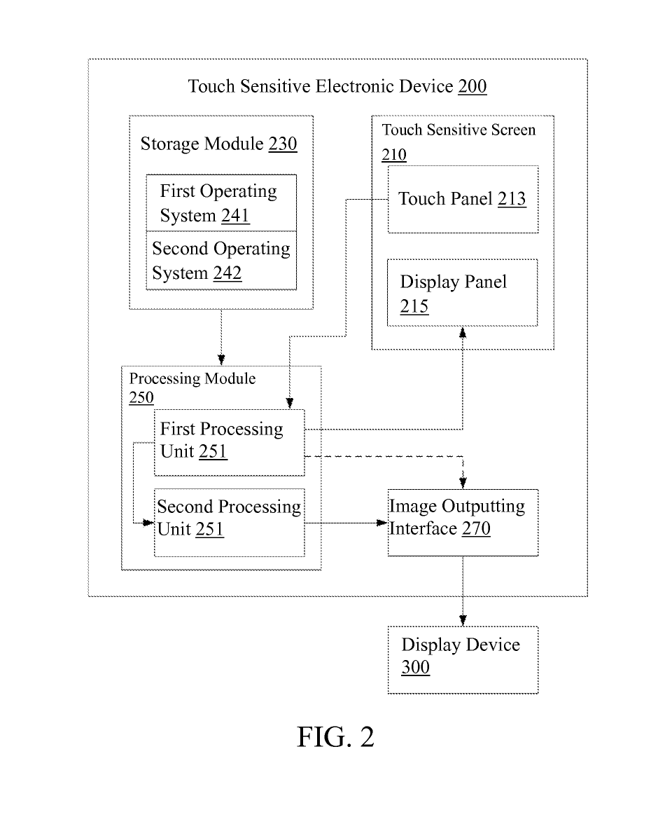

FIG. 2 is a schematic block diagram of the hardware of the touch sensitive electronic device 200 having dual operating systems according to an embodiment of the invention.

Referring to FIG. 2, the touch sensitive electronic device 200 includes a touch sensitive screen 210, a storage module 230, a processing module 250 and an image outputting interface 270. The processing module 250 is coupled with the touch sensitive screen 210 and the storage module 230. The image outputting interface 270 is coupled with the processing module 250.

The touch sensitive screen 210 includes a touch panel 213 and a display panel 215. The storage module 230 stores a first operating system 241 and a second operating system 242.

The processing module 250 runs the first operating system 241. When the image outputting interface 270 is connected to the display device 300, the touch sensitive screen 210 displays the virtual input interface under the first operating system 241. The processing module 250 runs the second operating system 242 and outputs the operation screen of the second operating system 242 to the display device 300 via the image outputting interface 270.

In one embodiment, the processing module 250 includes a first processing unit 251 and a second processing unit 252. Here, the processing module 250 may be substantially dual core or multi core processors corresponding to the first processing unit 251 and the second processing unit 252.

In another embodiment, the processing module 250 includes a first processing unit 251 which has a poorer performance and lower power consumption and a second processing unit 252 which has a better performance and higher power consumption. Under normal circumstances, the first processing unit 251 operates and the second processing unit 252 is under a power off or a suspend state. When it is necessary to run the second operating system 242, the second processing unit 252 is activated or awakened to its operating state. With such arrangement, the power consumption of the touch sensitive electronic device can be reduced to save the power consumption of the battery.

In some embodiments, the storage module 230 may include storage media such as a flash memory, a micro drive, a memory card or a solid state drive.

Here, the first operating system 241 and the second operating system 242 may be stored in the same storage unit or in different storage units. For example, the first operating system 241 may be stored in a flash memory, and the second operating system may be stored in a solid state drive. Thereby, the system access resources can be distributed to enhance the operation performance of the two operating systems.

The first operating system 241 may be the operating system for mobile phones or tablet computers, such as Android®. The second operating system 242 may be the operating system typically run on a desktop computer, such as Ubuntu®.

In one embodiment, the image outputting interface 270 may be connected to the display device 300 via a wired communication link. Here, the image outputting interface 270 may be an HDMI (High Definition Multimedia Interface) interface, a component video interface, an S Video interface, an AV terminal interface, a DVI (Digital Visual Interface) interface, a VGA (Video Graphics Array) interface or a display port interface.

In another embodiment, the image outputting interface 270 may be connected to the display device 300 via a wireless communication link. That is, the image outputting interface 270 may be a wireless communication interface adapted for image transmission, such as a WLAN (Wireless Local Area Network) interface or a WHDI (Wireless Home Digital Interface) interface.

In some embodiments, an image processing unit (not shown) may be connected between the processing module 250 and the image outputting interface 270. The image processing unit receives image signals from the processing module 250 and converts them into signals conforming to the format of the image outputting interface 270 to output to the image outputting interface 270.

In some embodiments, the first operating system 241 handles by default the control of the image outputting interface 270. When the second operating system 242 is to output image via the image outputting interface 270, the control is handed over to the second operating system 242. Therefore, in FIG. 2 a dotted line is used to connect the first operating system 241 and the image outputting interface 270.

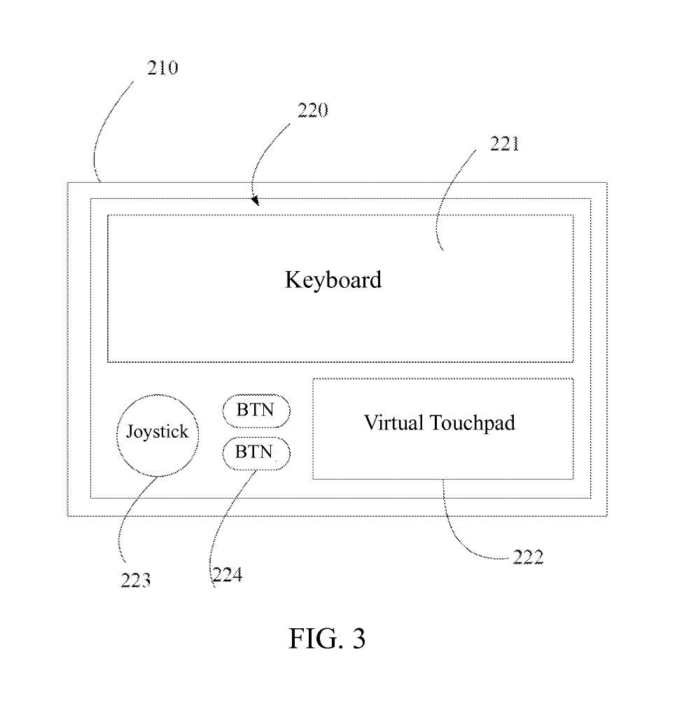

FIG. 3 is a schematic diagram of a virtual input interface 220 shown by the touch sensitive screen 210 according to an embodiment of the invention.

As shown in FIG. 3, the virtual input interface 220 may include, but not limited to, a virtual keyboard 221, a virtual touchpad 222, a virtual joystick 223, a virtual button 224, or the combination thereof. The virtual input interface 220 may be a native input interface of the first operating system 241, or may be another input interface adapted for the second operating system.

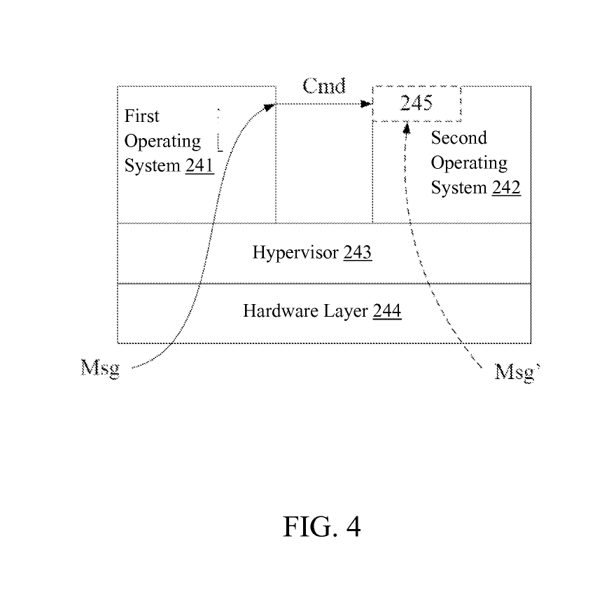

FIG. 4 is a schematic block diagram of the software of the touch sensitive electronic device 200 having dual operating systems according to an embodiment of the invention.

Referring to FIG. 4, the first operating system 241 and the second operating system 242 may be operated on a hypervisor 241. The hypervisor 243 is a virtual platform for different operating systems to operate thereon. The hypervisor 243 also controls a portion of the hardware resources (i.e., the hardware layer 244). The hardware layer 244 may include, but not limited to, processors, APICs (advanced programmable interrupt controllers), system counters and physical address spaces.

The processing module 250 converts the input instruction Cmd output by the virtual input interface 220 into an input message Msg′ generated corresponding to a physical input device (such as a physical keyboard), and send the input message Msg′ to the input interface 245 of the second operating system 242 (such as a keyboard driver).

As shown in FIG. 4, the touch panel 213, under the control of the first operating system 241, generates an input message Msg (such as the touched coordinate information) in response to a touch (such as the touch on the touch panel 213 by a user). The first operating system 241 converts the input message Msg into the input instruction Cmd (such as a letter “A”) according to the virtual input interface 220, and sends the input instruction Cmd to the input interface 245 (for example, the keyboard driver) of the second operating system 242. Then, the second operating system 242 executes corresponding actions (such as key in the letter “A”) according to the input instruction Cmd received.

Here, the input message Msg corresponds to the input instruction Cmd generated by a physical input device. That is, the input instruction Cmd may be viewed as being converted from the input message Msg′ generated by the physical input device. Therefore, the second operating system 242 can execute a corresponding input instruction Cmd according to the touch on the touch panel 213 as it is connected with a physical input device externally.

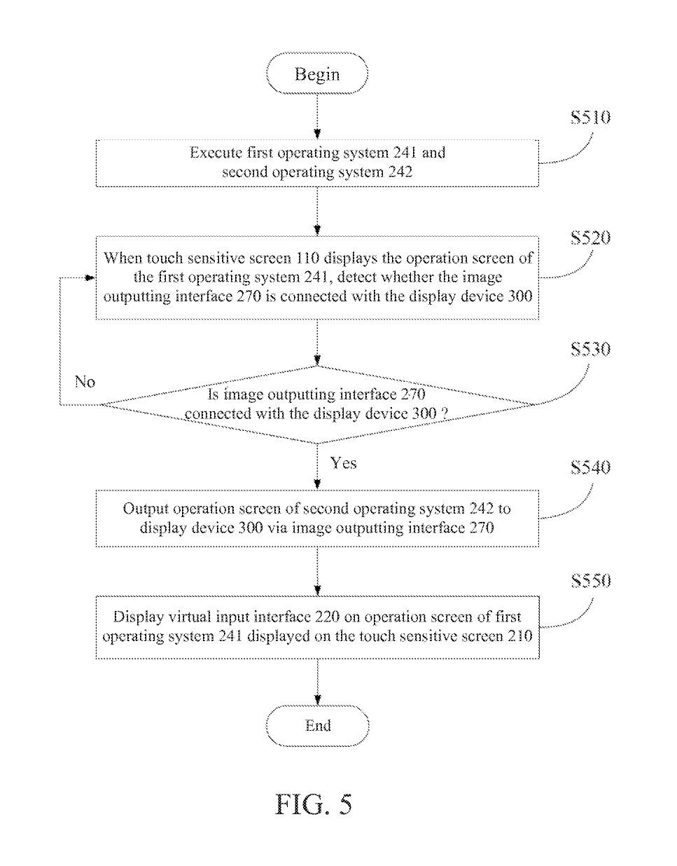

FIG. 5 is a flowchart showing the operation method (1) of the dual operating systems according to one embodiment of the invention.

Referring to FIG. 5, the operation method of the dual operating systems is adapted for the touch sensitive electronic device 200 described above. When the touch sensitive electronic device 200 is booted and initialized (for example, the hypervisor 243 and the hardware layer 244 described above are loaded), the first operating system 241 and the second operating system 242 are executed on the hypervisor 243 (step S510). Then, when the touch sensitive screen 110 displays the operation screen of the first operating system 241, the image outputting interface 270 is detected to see if it is connected with the display device 300 (step S520). In step S530, if the image outputting interface 270 is connected with the display device 300, the operation screen of the second operating system 242 is output to the display device 300 via the image outputting interface 270 (step S540); if no, the procedure returns back to step S520 to keep detecting whether the image outputting interface 270 is connected with the display device 300. After step S540, the virtual input interface 220 is displayed on the operation screen of the first operating system 241 displayed on the touch sensitive screen 210 (step S550).

Here, the sequence of step S540 and step S550 can be exchanged with each other.

In some embodiments, after step S520, and in particular between step S520 and step S530, the operation method of the dual operating systems may further include the step of providing a mode switching inquiry message for a user to select whether to output the operation screen of the second operating system 242. Thereby, the flexibility of the use of the touch sensitive electronic device 200 can be enhanced.

In some embodiments, if the user selects to output the operation screen of the second operating system 242, the operation screen of the second operating system 242 is output to the display device 300 via the image outputting interface 270. If the user does not select to output the operation screen of the second operating system 242, the operation screen of the first operation system 241 may be output to the display device 300 via the image outputting interface 270.

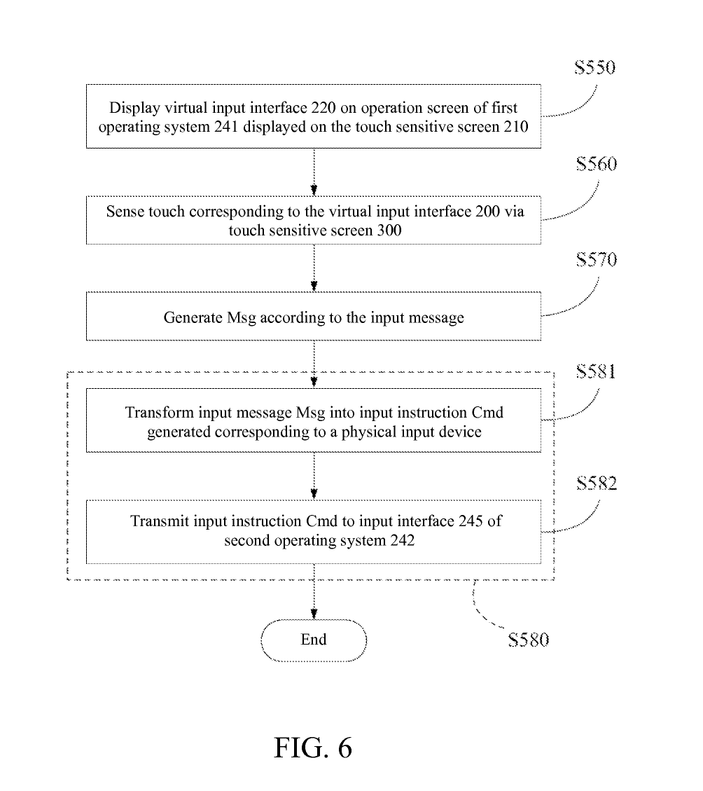

FIG. 6 is a flowchart showing the operation method (2) of the dual operation systems according to one embodiment of the invention.

Referring to FIG. 6, the operation method of the dual operating systems further includes step S560 and subsequent steps after step S550 described previously. In step S560, the first operating system 241 senses a touch corresponding to the virtual input interface 200 via the touch sensitive screen 300. That is, after step S540 and step S550 are executed, the user can examine the operation screen of the second operating system 242 at the display device 300, and can operate the second operating system 242 via the virtual input interface 220 displayed on the touch sensitive screen 210. When the user touches the touch sensitive screen 210 to perform operations, the touch sensitive screen 210 senses the touch corresponding to the virtual input interface 200.

After step S560, an input message Msg is generated according to the touch (step S570). That is, via step S560 and step S570, the first operating system 241 receives the input message Msg generated by the virtual input interface 200.

Then, the input message Msg is used to control the second operating system 242 (step S580). Here, step S580 may further include step S581 and step S582.

In step S581, the input message Msg is transformed into an input instruction Cmd generated corresponding to a physical input device. Then, in step S582, the input instruction Cmd is transmitted to the input interface 245 of the second operating system 242. With this arrangement, the second operating system 242 can execute the corresponding input instruction Cmd according to touch on the touch panel 213 as being connected with an external physical input device.

In some embodiments, the storage module 230 previously described may be a computer readable storage medium (for example, a non-temporary computer readable storage medium such as non-volatile memory), with a computer operable program stored thereon. This computer operable program is adapted for the touch sensitive electronic device 200 that can run the first operating system 241 and the second operating system 242 simultaneously, and for the operation method of the dual operating systems described previously.

Here, the operation method of the dual operating systems described previously is not limited to run the first operating system 241 and the second operating system 242 simultaneously, but can run more operating systems simultaneously.

To sum up, according to the operation method of dual operating systems, the touch sensitive electronic device 200 having dual operating systems, and the computer readable storage medium according to the invention, the complete input interface 245 can be displayed on the touch sensitive screen 210 by the first operating system 241, while the display screen of the second operating system 242 can be output via the image outputting interface 270. With such arrangement, the issue existed in the prior art that the touch sensitive screen 210 cannot provide a sufficient input area and a sufficient information display area can be solved.

What is claimed is:

1. A operation method of dual operating systems adapted for a touch sensitive electronic device that is capable of operating a first operating system and a second operating system simultaneously, the touch sensitive electronic device comprising a touch sensitive screen and an image outputting interface, the operation method comprising:
detecting whether the image outputting interface is connected with a display device when the touch sensitive screen displays the operation screen of the first operating system;
outputting the operation screen of the second operating system to the display device via the image outputting interface when the image outputting interface is connected with the display device; and
displaying a virtual input interface on the operation screen of the first operating system displayed on the touch sensitive screen.

2. The operation method of dual operating systems according to claim 1, further comprising:
the first operating system receiving an input message generated by the virtual input interface; and
controlling the second operating system using the input message.

3. The operation method of dual operating systems according to claim 2, wherein the step of controlling the second operating system using the input message comprises:
transforming the input message into an input instruction generated corresponding to a physical input device; and
transmitting the input instruction to an input interface of the second operating system.

4. The operation method of dual operating systems according to claim 1, wherein when the display device is connected with the touch sensitive electronic device via the image outputting interface, the method further comprises:
providing a mode switching inquiry message for a user to select whether to output the operation screen of the second operating system.

5. The operation method of dual operating systems according to claim 4, wherein if the user selects to output the operation screen of the second operating system, the operation screen of the second operating system is output to the display device via the image outputting interface, if the user does not select to output the operation screen of the second operating system, the operation screen of the first operating screen is output to the display device via the image outputting interface.

6. A computer readable storage medium having dual operating systems, storing a computer operable program adapted for a touch sensitive electronic device capable of operating a first operating system and a second operating system simultaneously, the touch sensitive electronic device comprising a touch sensitive screen and an image outputting interface, the program operating the following steps:
detecting whether the image outputting interface is connected with a display device when the touch sensitive screen displays the operation screen of the first operating system;
outputting the operation screen of the second operating system to the display device via the image outputting interface when the image outputting interface is connected with the display device; and
displaying a virtual input interface on the operation screen of the first operating system displayed on the touch sensitive screen.

7. The computer readable storage medium according to claim 6, wherein the steps operated by the program further comprises:
the first operating system receiving an input message generated by the virtual input interface; and
controlling the second operating system using the input message.

8. The computer readable storage medium according to claim 7, wherein the step of controlling the second operating system using the input message comprises:
transforming the input message into an input instruction generated corresponding to a physical input device; and
transmitting the input instruction to an input interface of the second operating system.

9. The computer readable storage medium according to claim 6, wherein the steps operated by the program further comprises:
when the display device is connected with the touch sensitive electronic device via the image outputting interface, providing a mode switching inquiry message for a user to select whether to output the operation screen of the second operating system.

10. The computer readable storage medium according to claim 9, wherein the steps operated by the program further comprises:
if the user selects to output the operation screen of the second operating system, the operation screen of the second operating system is output to the display device via the image outputting interface, if the user does not select to output the operation screen of the second operating system, the operation screen of the first operating screen is output to the display device via the image outputting interface.

11. A touch sensitive electronic device having dual operating system, comprising:
a storage module storing a first operating system and a second operating system;
a processing module capable of operating the first operating system and the second operating system simultaneously;
an image outputting interface coupled with the processing module for connecting with a display device, when the image outputting interface being connected with the display device, the operation screen of the second operating system being output to the display device via the image outputting interface; and
a touch sensitive screen for displaying the operation screen of the first operating system, when the image outputting interface being connected with the display, the operation screen of the first operating system on the touch sensitive screen displaying a virtual input interface.

12. The touch sensitive electronic device according to claim 11, wherein the first operating system receives an input message generated by the virtual input interface and transmits the input message to control the second operating system.

13. The touch sensitive electronic device according to claim 12, wherein the processing module receives the input message outputted and transforms the input message into an input instruction generated corresponding to a physical input device, and transmit the input instruction to an input interface of the second operation system.

14. The touch sensitive electronic device according to claim 11, wherein the image outputting interface is connected with the display device via a wired communication link.

15. The touch sensitive electronic device according to claim 11, wherein the image outputting interface is connected with the display device via a wireless communication link.

16. The touch sensitive electronic device according to claim 11, wherein the virtual input interface comprises a virtual keyboard, a virtual touchpad, a virtual joystick, a virtual button or a combination thereof.
